(19) United States
(12) Patent Application Publication
(10) Pub. No.: US 2005/0029347 A1
(43) Pub. Date: Feb. 10, 2005

(54) Automatic number plate recognition system

(76) Inventors: Lawson John Noble, Herts (GB); Frank James Thomson, Herts (GB); Nico Bekooy, Herts (GB)

Correspondence Address: KLARQUIST SPARKMAN, LLP, 121 SW SALMON STREET, SUITE 1600, PORTLAND, OR, 97204, US

(21) Appl. No.: 10/473,381

(22) PCT Filed: Mar. 22, 2002
(86) PCT No.: PCT/GB02/01388

(30) Foreign Application Priority Data
Mar. 28, 2001 (GB) 0107779.1

(51) Int. Cl. G07B 15/02; G06K 7/10

(52) U.S. Cl. 235/384; 235/472.01

(57) ABSTRACT

A handheld automatic number plate recognition system comprising a handheld personal computer and a camera, the camera being operable to capture images and the computer including a processor to identify a number plate from an image captured by the camera.

THIS INVENTION RELATES to an automatic number plate recognition system and more particularly to a handheld automatic number plate recognition system.

Automatic number plate recognition systems comprise a frame grabber normally in the form of a video camera, charge coupled device or the like in combination with a computer system which incorporates an algorithm to recognise and interpret the characters making up the licence number on a number plate. Automatic number plate recognition systems typically use a powerful computing platform such as a Pentium based desk top computer. Video images are captured from video cameras often working in the infrared spectrum. The cameras are fixedly mounted at the roadside, on motorway bridges, on gantries and/or on or near traffic barriers and gates. These fixed installations are primarily used for obtaining and reporting details of passing traffic, for logging staff or visitors onto commercial premises and allowing or restricting access to such premises by automatically opening barriers or the like. Traditional systems are based on standard or industrial personal computers and standard video cameras usually set to a high shutter speed of at least 1/500th sec., the resultant combination being bulky, expensive, difficult to install, necessitating hardwiring and sufficiently permanent fixing to prevent tampering. Since the installations are usually open to the elements, they require routine checking and maintenance.

The fixed installation systems cannot perform the full range of functions since they are by their definition, fixed to a dedicated site. Whilst such a fixed installation may be useful, for example, to monitor the ingress and egress of vehicles at a car park entrance or exit, the systems are not able to be used by personnel to check which actual vehicles are present in a car park during an emergency situation.

It is an object of the present invention to seek to provide an automatic number plate recognition system which does not suffer from the above mentioned problems.

Accordingly, one aspect of the present invention provides a handheld automatic number plate recognition system comprising a handheld personal computer and a camera, the camera being operable to capture images and the computer including a processor to recognise a number plate from an image captured by the camera.

Advantageously, the computer is operable to power down the camera when not in use.

Preferably, the processor includes means to recognise and identify rectangular areas, each such recognised area comprising a possible number plate to be recognised.

Conveniently, the processor sets a number plate threshold range outside of which a captured image will not be processed.

Advantageously, the threshold range is between 1,000 and 10,000 pixels.

Preferably, the threshold range is between 1,800 and 5,000 pixels.

Conveniently, the computer has a memory in which is stored a plurality of known number plates.

Advantageously, the system is portable.

Preferably, the camera is attached to the computer.

Conveniently, the computer includes a display operable to indicate a recognised number plate.

Advantageously, the computer includes a speaker and a synthesiser to enunciate the characters making up a recognised number plate.

Preferably, an infrared light source and battery pack for the infrared light source is separately attached to the system.

Conveniently, the infrared light source comprises a cluster of LED light sources.

Advantageously, any infrared cut filter provided in the camera is removed.

Preferably, the camera is provided with an infrared band-pass filter allowing infrared light to pass into the camera.

Conveniently, the infrared band-pass filter allows infrared light having a wavelength of between 800 and 900 nanometres to enter the camera.

Advantageously, a separate module is fitted to the system containing a battery and a modem to provide the system with a telecommunication capability.

Preferably, the system is operable to respond to a recognised number plate matched with a stored number plate by transmitting data from that plate to a remote computer for subsequent action.

Conveniently, the mode of telecommunication is an SMS text message.

In order that the present invention may be more readily understood, embodiments thereof will now be described, by way of example, with reference to the accompanying drawings, in which:

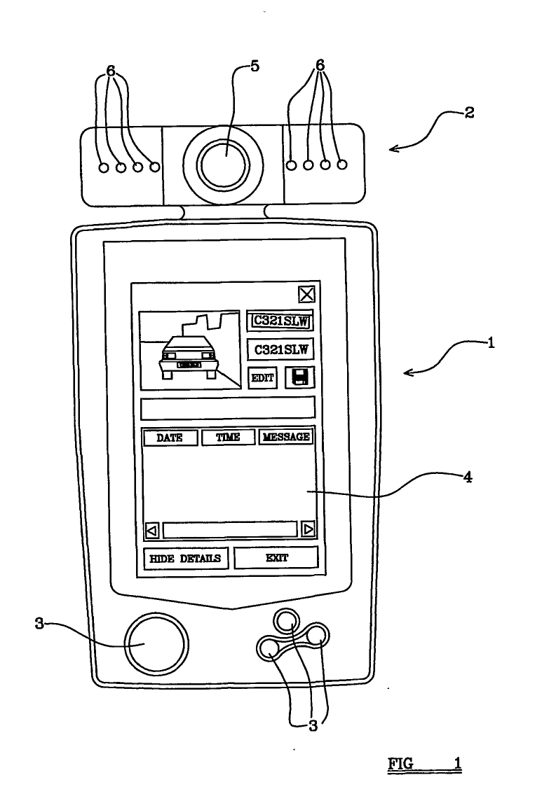

FIG. 1 is an automatic number plate recognition system embodying the present invention.

A preferred embodiment of the present invention is shown in FIG. 1 and comprises a handheld personal computer 1 which in the present instance comprises a Casio Cassopeia E115, E125 or an EG800 or equivalents thereof having an expansion slot to accept a camera or frame grabber 2. The computer 1 has a processor, a memory, a plurality of user interface keys or buttons 3 and a touch sensitive display screen 4. With the camera 2 attached to the hand held computer 1, the resultant unit meets the hardware requirements of an automatic number plate recognition system.

The processor is operable to run automatic number plate recognition software which comprises an engine which runs under Windows CE or Pocket Windows.

The automatic number plate recognition software processes images captured by the camera. Each image is frozen and the software scans each image in the first instance to look for and identify any rectangular boundaries. In order to reduce the amount of processing required to be done by the computer and to ensure that only readable number plates are presented for processing, the software applies a minimum size of number plate to the identified rectangular boundaries or shapes. Accordingly, the user of the system is able to set a threshold so that rectangular shapes comprising number plates below a certain size are ignored by the software. It has been found that an optimum minimum size to ensure that a number plate is readable by the software is in the region of 1,800 to 5000 pixels but possibly as low as 1,000 pixels and as high as 10,000 pixels.

Having identified rectangular areas having a pixel size in the threshold range, the software copies the original image which is then analysed to search for the characters making up the number plate.

Each character within the rectangular area is given a confidence factor and a semantic check is carried out. For example, number plates from cars of different nationalities have different formats, the letters and numbers making up the number plate being arranged according to different rules. For example, British number plates are at the present time divided into three groupings comprising a letter prefix followed by three numbers and a three letter suffix. The three letter suffix is spaced apart from the three numbers. A Dutch number plate comprises three groupings consisting of a two letter prefix, a two number group and a two letter suffix, the groups being separated by dashes. The semantic check can be applied to the number plate either by assuming or expecting that in a default mode all number plates will be in the format of the country where the device is being used or to determine the likely nationality of a vehicle and to provide a better likelihood of success in distinguishing between confusingly similar letters and numbers such as “B” and the numeral “8” on the basis of the location of the character in the group of characters making up the number plate. For example, it is more likely that the first character in a British number plate will be the letter “B” rather than the numeral “8”.

An overall confidence factor is then applied to the number plate.

The algorithms which apply the confidence factors and the overall confidence factor work by matching character shapes to a predefined set of standard fonts looking for similarities therebetween and according a confidence factor depending upon the number of similarities found. It is important to note that the operating software is not neural net based as such techniques are only suitable in certain locations with certain patterns of traffic and can be over-taught or “grand-mothered”.

The resolution of the camera 2 for use with the handheld computer 1 is approximately half the resolution of a standard video grabber, being 320×240 pixels as opposed to 640×288. A resolution at 320×288 is envisaged for more powerful processors. Thus, the software is configured to set a fairly narrow threshold range of between at least 1,000 pixels and no more than 10,000 pixels, the optimum size range to be processed being between 1,800 and 5,000 pixels.

Owing to the slower processing speeds and battery constraints of handheld personal computers, the automatic number plate recognition system embodying the present invention has been adapted to operate significantly differently from non-portable systems.

A preview mode can be selected when the camera is switched on so that a live video preview is shown on the display screen 4 allowing a user to point the device accurately at a parked vehicle. When the user presses a “capture” button 3, the frame is grabbed and processing begun.

Once an image has been captured, only the region recognised as the number plate, the plate patch, is saved. The plate patch is processed and the number plate details are displayed on the screen and preferably an audible tone is provided.

In a preferred embodiment the automatic number recognition system is pre-loaded with a list of known number plates.

The displayed number is looked up in a database held by the computer of a stored list of “wanted” number plates and compared with all the entries and if a match is found, then a predetermined message is displayed and preferably a further warning tone is emitted. The database can be readily and regularly updated.

Upon a match being detected, further information concerning the identified vehicle can be obtained by pressing a “details” button 3 which displays information such as the make, model, drivers details and the date of the last visit of the vehicle to the location. An “action” button 3 is also provided to display the letters and numbers of the identified number plate in police call signs, for example “S 443 NNR” would be displayed as:
Sierra
Four
Four
Three
November
November
Romeo.

The data relating to the frame grabbing operation comprising the number plate details, the time and date and the location, if known, are saved in the computer's memory for later uploading when synchronising the handheld PC with a master PC.

In this simple mode of operation, the camera 2 is powered down after each frame is grabbed and the real time preview is also disabled so as to save power. Indeed, in another embodiment of the present invention, the live preview mode can be dispensed with by confident users who are able simply to point the system at a vehicle and press the “capture” button to grab an appropriate frame.

Other modes of operation which are possible comprise the ability to grab multiple frames. The ability to grab multiple frames gives higher accuracy of number plate recognition. Typically, the software would grab several images, in the region of 3 to 5 grabs, and analyse all of them. Thus, several distinct attempts are made to analyse the number plate of a vehicle and arrive at a consensus decision to report the recognised number plate and make this information available for display, storage, or activation of a device by the computer.

It has been noted that the camera 2 provides a substantial drain on the power resources of the handheld personal computer 1 and is accordingly disabled whenever possible to prolong battery life. Battery life is in the region of four hours but further battery packs can be provided having four, seven or thirteen hours respectively. A particular advantage of the Casio handheld PC's is that the batteries can be unclipped and swapped in the field without loss of data.

The automatic number plate recognition software can also be expanded to include a voice synthesis module to speak the recognised number plate out loud using call signs. This feature is extremely useful in bright light conditions when the screen is hard to read. This digital module does, however, use additional battery power. So as to give some shielding from ambient light which can insert a condition to make the screen of the hand held personal computer difficult to read, a housing for the personal computer and camera is provided incorporating a shielding cowling.

Automobile number plates have a retro-reflective backing, the characters making up the number plate being non-reflective. The retro-reflective backing reflects in the region of 85% of the incident light in the infrared spectrum making the number plate extremely visible when illuminated by an infrared light source.

In one embodiment of the present invention, the camera 2 is provided with a camera lens 5 and a plurality of infrared light sources 6 either side of the lens. Any standard infrared filter provided on the camera is preferably removed to facilitate camera operation in the infrared spectrum. It is important that the infrared light sources 6 are located adjacent the lens 5 because the retro-reflective nature of the backing requires the incident light and the reflective light paths to be separated by no greater than in the region of 5°. Greater separation of the light paths dramatically reduces the percentage of reflected light thereby reducing the performance of the system. Not only does infrared operation of the device allow the device to be used in low light level applications but also greatly serves to improve recognition of number plates in cluttered environments. Also, in instances where the rectangular number plate is not clearly bordered by a black outline or the like, the infrared illumination of the number plate area serves to clearly distinguish this rectangular portion from its surroundings.

It is also envisaged that a small cluster of light emitting diodes can be provided in a package which is strapped or clipped to the computer 1 or frame grabber/camera 2, the package containing rechargeable batteries for powering the LED cluster. The cluster of LED light sources serve to illuminate number plates at a distance of 2 or 3 metres and allow high quality reading in low light conditions or night time use.

It is important to ensure the clearest reading and to maximise power efficiency that the number of frame grabs required to capture accurately a recognisable image is minimised. To this end, any infrared cut filter provided in the camera 2 is removed. This allows more infrared light to enter the camera but as a consequence distorts the colours of the captured image but this is not problematic for the recognition software which is able to concentrate on the clearly delineated reflected infrared image from the plate to be recognised.

Preferably, any infrared cut filter is replaced with an infrared band-pass filter which permits infrared light in the bandwidth range 800-900 nanometres to enter the camera. This further improves the operational performance of the recognition software minimising the number of frame grabs required to capture a recognisable number. These steps also serve to maximise battery life by making relevant image capturing more efficient.

It is also envisaged that a clip-on module can be fitted underneath the unit containing a larger battery and a small GSM modem which gives the unit a dialling and messaging capability. The software is structured to respond to a number plate hit (i.e. the recognition of a “wanted” number plate held on the computer database) by transmitting data from that plate (e.g. the plate details, location, time and date) to a remote host computer for subsequent action. The mode of communication may be as a short message service (SMS) text message to a mobile phone, to a pager or directly to the remote computer.

The provision of the GSM modem allows a user to request and download an update from the remote computer of the latest number plate database (hit list) which is transmitted to the unit over the GSM network and used to update the stored database. This removes the need to return to base to gather the latest data on, for example, the latest stolen or suspect cars.

It is also envisaged that the camera and hand held personal computer be configured within a single housing, preferably ruggedised.

Preferably, the infrared light sources 6 should be controllable by the hand held personal computer so as to be pulsed to illuminate the subject only whilst the camera is in operation thereby saving battery power.

It is preferred that the hand held automatic number plate recognition system is operable to output just a single number plate rather than offering a plurality of close alternatives.

It is also envisaged that a more powerful battery belt may be provided which connects to the hand held personal computer by means of a cable.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A handheld automatic number plate recognition system comprising a handheld personal computer and a camera, the camera being operable to capture images and the computer comprising a processor to identify a number plate from an image captured by the camera, wherein the processor comprises means to identify rectangular areas, each such identified area comprising a possible number plate to be interpreted.

2. A system according to claim 1, wherein the computer is operable to interpret the image of the plate and output a string of recognized characters in response thereto.

3. A system according to claim 1 or 2, wherein the computer is operable to power down the camera when not in use.

4. A system according to any preceding claim, wherein the processor includes means to identify rectangular areas, each such identified area comprising a possible number plate to be interpreted.

5. A system according to any preceding claim, wherein the processor sets a plate size threshold range outside of which a captured image will not be processed.

6. A system according to claim 5, wherein the threshold range is between 1,000 and 10,000 pixels.

7. A system according to claim 6, wherein the threshold range is between 1,800 and 5,000 pixels.

8. A system according to any preceding claim, wherein the computer has a memory in which is stored a plurality of known number plates.

9. A system according to any preceding claim, wherein the system is portable.

10. A system according to any preceding claim, wherein the camera is attached to the computer.

11. A system according to any preceding claim, wherein a single housing holds the camera and the computer.

12. A system according to any preceding claim, wherein the computer includes a display operable to indicate a recognized number plate.

13. A system according to any preceding claim, wherein the computer includes a speaker and a synthesizer to enunciate the characters making up a recognized number plate.

14. A system according to any preceding claim, wherein the camera is operable in the infrared spectrum and the system has at least one infrared source.

15. A system according to claim 14, wherein the or each infrared source is located adjacent the camera such that a path of incident light from the infrared source is within 5° of a return path of light reflected from a subject.

16-25. (Canceled).
